(19) United States
(12) Patent Application Publication
(10) Pub. No.: US 2005/0055296 A1
(43) Pub. Date: Mar. 10, 2005

(54) Method and system for underwriting and servicing financial accounts

(76) Inventors: Michael Hattersley, San Francisco, CA (US); Thomas Jadico JR., Conshohocken, PA (US); Seong-Kun Oh, Piedmont, CA (US)

Correspondence Address: JACKSON & CO., LLP, 6114 LA SALLE AVENUE, SUITE 507, OAKLAND, CA, 94611-2802, US

(21) Appl. No.: 10/657,456

(22) Filed: Sep. 8, 2003

(51) Int. Cl. G06F 17/60

(52) U.S. Cl. 705/35

(57) ABSTRACT

Method and system for providing financial account underwriting and servicing exclusively using online transactions by requiring a link to the account holder's bank account as a condition of account approval process and account servicing performed exclusively online with the account holders including the steps of receiving account application information including a bank account information, depositing at least one deposit amount to the bank account corresponding to the received bank account information, receiving a deposit verification amount, from the applicant, confirming the deposit verification amount received from the applicant, and generating a financial account corresponding to the received account application information, where the financial account is electronically linked to the bank account for periodic debit transaction to withdraw funds from the linked bank account and to deposit the withdrawn funds into the linked financial account, and a server terminal configured to perform these steps are provided.

### BACKGROUND OF THE INVENTION

The present invention relates to financial transactions. More specifically, the present invention relates to unique validation features for secure online application, underwriting, and servicing processes of financial accounts such as credit card accounts that materially mitigate (a) front end origination fraud for new applicants and (b) charge off liability associated with accounts which have a propensity to default.

With the rapid development to improve security and integrity of electronic information exchange, there has been a steady increase in online financial transactions by consumers, for example, for purposes of banking, to checking balances on credit card accounts, and to place brokerage trade transactions, to name a few. Encryption technology and secure data networks have substantially helped the consumers to address concerns related to security and protection of personal as well as financial information.

Additional advantage of online electronic financial transaction include faster service (so as to avoid long lines at the bank, for example), 24 hour access (so that the consumers are not limited to the traditional operating hours of the financial institutions, for example), substantially improved data accuracy integrity. For instance, by entering the personal information themselves, the consumers are offered an opportunity to ensure that the information entered is accurate, and thus removed the potential for error by third parties, as for example, that may occur when such information is provided over the telephone to a financial institution's representative.

On the other hand, even with improvements in data encryption, secure online transaction and the like, the instances of potential fraudulent financial transactions are also likely. The higher the number of fraudulent transactions, the higher the cost related to servicing such financial accounts, leading to higher costs which are eventually passed onto the customers by way of higher late fee penalties, over-drawn account fees and other transactional fees. Moreover, because online financial transactions remove all interpersonal contacts between the financial institutions and the customers (and potential customers), it is also difficult for the financial institutions to ascertain and validate with certainty the characteristics of the customer base (and the potential customer base) aside from the information provided by the customers.

In view of the foregoing, it would be desirable to have an online financial transaction enabling system and method which allows secure information exchange, and that enables the on-going validation of online exclusive account underwriting, servicing and maintenance. Moreover, it would be desirable to have an online financial transaction enabling system and method which allows applicants to self select on behalf of the financial institution, the account and customer type most desirable to the financial institution by selecting those account applicants that agree to the verification and servicing processes required by financial institution in order for the customer to maintain an account with the financial institution.

### SUMMARY OF THE INVENTION

In view of the foregoing, there is provided a method of providing underwriting and/or servicing of an financial account, comprising the steps of receiving account application information including a bank account information, depositing at least one deposit amount to the bank account corresponding to the received bank account information, receiving a deposit verification amount, comparing the received deposit verification amount with the deposited at least one deposit amount, and generating a financial account corresponding to the received account application information, where the financial account is electronically linked to the bank account. This process validates the customer as holder of a bank account (checking or savings) with another known financial institution.

In one aspect, the method further includes the step of receiving a periodic debit transaction amount, where the periodic debit transaction amount is periodically debited (for example, every 30 days) from the bank account electronically to the financial account. Moreover, the periodic debit transaction amount may include one of a full balance of the financial account, a minimum payment amount of the financial account, and a minimum payment amount of the financial account plus a predetermined payment amount.

The method in another aspect may further include the step of performing credit verification based on the received account application information, where the step of performing credit verification includes the steps of transmitting the account application information to a credit bureau, receiving a credit history information corresponding to said transmitted account application information.

In an additional aspect of the present invention, the financial account may include a credit card account.

Additionally, the method in yet another aspect of the present invention may include the steps of generating an financial account default notification when the balance amount of the linked bank account falls below a predetermined minimum level, and transmitting said financial account default notification.

A system for providing underwriting and/or servicing of an financial account in accordance with another embodiment of the present invention includes a data network, a user terminal operatively coupled to said data network configured to transmit and receive data therefrom, and a server terminal operatively coupled to said data network, the server terminal further configured to: receive account application information including a bank account information from said user terminal, deposit at least one deposit amount to the bank account corresponding to the received bank account information, receive receiving a deposit verification amount from said user terminal, compare the received deposit verification amount with the deposited at least one deposit amount, generate a financial account corresponding to the received account application information, where the financial account is electronically linked to the bank account.

A program storage device readable by a machine, tangibly embodying a program of instructions executable by the machine to perform a method of providing underwriting and/or servicing of an financial account in accordance with still another embodiment of the present invention includes the steps of receiving account application information including a bank account information, depositing at least one deposit amount to the bank account corresponding to the received bank account information, receiving a deposit verification amount, comparing the received deposit verification amount with the deposited at least one deposit amount, and generating a financial account corresponding to the received account application information, where the financial account is electronically linked to the bank account. The unique attributes of this process, specific to each customer, is then incorporated into the credit scoring of the customer.

These and other features and advantages of the present invention will be understood upon consideration of the following detailed description of the invention and the accompanying drawings.

### BRIEF DESCRIPTION OF THE DRAWINGS

FIG. 1 is a block diagram of the overall system for executing the transactions in accordance with one embodiment of the present invention;

FIG. 2 is a flowchart illustrating the account application process in accordance with one embodiment of the present invention;

FIG. 3 is a flowchart illustrating the account application credit verification process in accordance with one embodiment of the present invention;

FIG. 4 is a flowchart illustrating the bank account link verification procedure in accordance with one embodiment of the present invention;

FIG. 5 is a tabular illustration of the account application information received by the server terminal and stored in the database at the server terminal in accordance with one embodiment of the present invention;

FIG. 6 is a tabular illustration of the credit card account information stored in the database at the server terminal in accordance with one embodiment of the present invention;

FIG. 7 is a tabular illustration of the default account information stored in the database at the server terminal in accordance with one embodiment of the present invention;

FIG. 8 is a flowchart illustrating the account application procedure at the user terminal in accordance with one embodiment of the present invention;

FIG. 9 is a flowchart illustrating the account application procedure at the user terminal in accordance with another embodiment of the present invention;

FIG. 10 is a flowchart illustrating the linked bank account balance information verification procedure for the corresponding credit card account in accordance with one embodiment of the present invention;

FIG. 11 is a flowchart illustrating the linked bank account balance insufficient level processing procedure for the corresponding credit card account in accordance with one embodiment of the present invention; and

FIG. 12 is a flowchart illustrating the default credit card account processing procedure in accordance with one embodiment of the present invention.

### DETAILED DESCRIPTION OF THE INVENTION

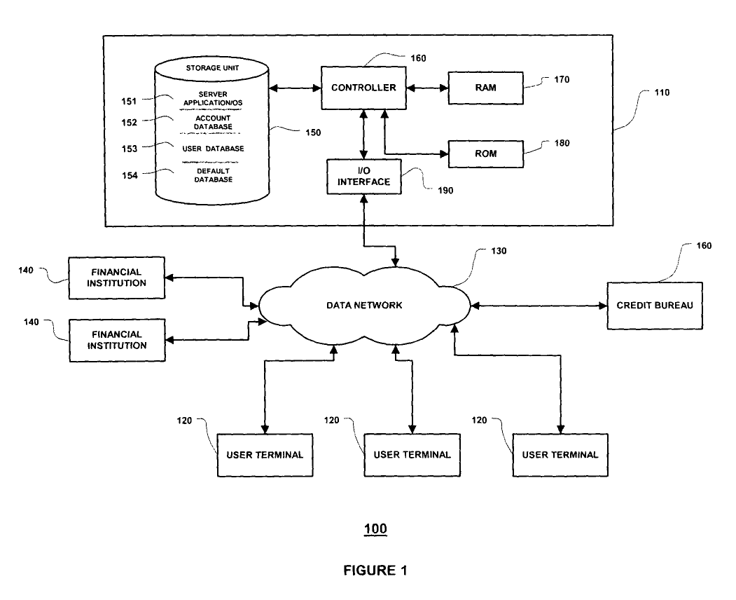

FIG. 1 is a block diagram of the overall system 100 for executing the transactions in accordance with one embodiment of the present invention. Referring to the Figure, there is provided a server terminal 110 operatively coupled to one or a plurality of user terminals 120 via a data network 130. In one aspect, the one or a plurality of user terminals 120 may include one of a desktop computer, a laptop computer, an internet enabled personal digital assistant (PDA), a pager, an integrated PDA and telephone, or any other electronic device capable of and configured to communicate data over a data network. Referring to the Figure, the data network 130 may include the internet or any other data network which enables data communication in a secure and timely manner. In one embodiment, the data network 130 may be configured to transmit and receive encrypted data for preserving confidential information such as account passwords and user identification information.

Referring to FIG. 1, also shown in the overall system 100 are financial institutions 140 operatively coupled to the data network 130. In one embodiment, the financial institutions 140 include banks, credit unions, and other such financial institutions which offer financial accounts such as checking accounts to the consumers. As will be discussed in further detail below, in one embodiment, the server terminal 110 may be configured to communicate with the financial institution 140 to deposit and debit money from a financial account corresponding to a credit card account holder. Furthermore, the account holder may access the financial account at the financial institution 140 via the data network 130 securely using encryption to conduct financial transactions therewith.

Also shown in FIG. 1 is a credit bureau 160 which is configured to be accessible by the server terminal 110 via the data network 130. As discussed in further detail below, the credit bureau 160 is configured to provide credit information corresponding to an financial account applicant received by the server terminal 110.

Referring again to FIG. 1, the server terminal 110 in one embodiment includes a controller 160, a random access memory (RAM) 170 operatively coupled to the controller 160, a read-only memory (ROM) 180 also operatively coupled to the controller 160, and an Input/Output (I/O) interface 190, additionally operatively coupled to the controller 160 and also configured to communicate with the data network 130 to receive and to transmit data. In one embodiment, the controller 160 may include a commercially available microprocessor configured to control data retrieval and transmission to and from the various components of the server terminal 110, For example, in one embodiment, the controller 160 may be configured to retrieve and/or store data to/from the RAM 170, access data stored in the ROM 180, and also to control the operation of the I/O Interface 190 for data communication with the user terminals 120, the financial institutions 140 and the credit bureau 160 via the data network 130.

As can be further seen from FIG. 1, the server terminal 110 in one embodiment further includes a storage unit 150. The storage unit 150 as shown in FIG. 1 includes server applications/operating system (OS) 151, account database 152, user database 153, and default database 154. In one aspect of the present invention, the controller 160 may be configured to store account information received from the user terminals 120 in the account database 152, and the user database, while generating and maintaining the data in the default database 154 corresponding to the respective accounts stored in the account database 152. In a further aspect of the present invention, the server applications/OS 151 may be configured to provide instruction sets to the controller 160 to perform data communication with the user terminals 120, the financial institutions 140, and the credit bureau 160 via the data network 130, and also to store, retrieve and/or update data in one or more of the respective account database 152, user database 153, and the default database 154.

It should also be noted that while FIG. 1 shows three user terminals 120, two financial institutions 140 and one credit bureau 160, within the scope of the present invention, additional or fewer user terminals 120, financial institutions 140 and credit bureau 160 are contemplated. Moreover, while only one server terminal 110 is shown in the embodiment shown in FIG. 1, within the scope of the present invention, one or more server terminals 110 may be provided and operatively coupled, for example, in a distributed manner to perform the tasks allocated thereto and described in further detail below.

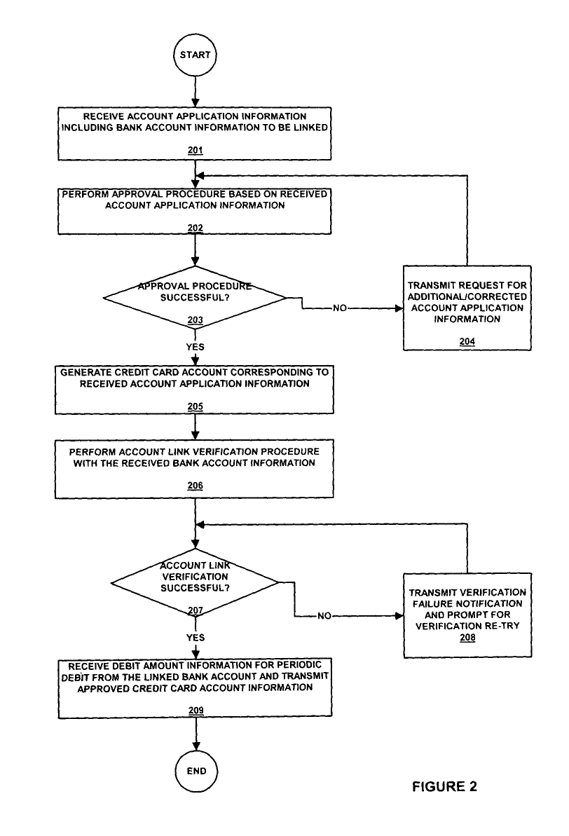

FIG. 2 is a flowchart illustrating the account application procedure in accordance with one embodiment of the present invention. More specifically, the account application procedure as shown in FIG. 2 in one embodiment is configured as back end processes of the overall system 100 to be performed, for example, by the server terminal 110 shown in FIG. 1.

Referring now to FIG. 2, at step 201, the server terminal 110 detects the transmission of application information, to apply for a financial account such as a credit card account, received from one of user terminal 120 via the data network 130. In one embodiment, the application information may include the applicant's contact information such as name, address, telephone numbers, and electronic mail (email) address, applicant's social security number information (for purposes of verifying applicant's credit history, for example, as will be discussed in further detail below), and applicant's income information such as annual gross income and employment history. Also received from the user terminal 120 is the applicant's bank account information such as the applicant's bank routing number information and the account number information. As discussed in further detail below, in order to complete the initial financial account application process, the applicant is required to transmit one of applicant's bank account information to be operatively linked to the financial account for which the applicant is applying.

In one aspect, the applicant is prompted to provide all of the information discussed above in order to complete the initial financial account application process. More specifically, the user terminal 120 may display (using a display unit such as a computer monitor, an LCD display screen, or any such similar devices operatively coupled to the user terminal) a user interface for the financial account application such as an internet webpage. Accordingly, the applicant simply needs to provide the financial account application information requested on the internet webpage and performs a transmit function at the user terminal 120 to transmit the account application information to the server terminal 110. In one embodiment, the account application information transmitted via the data network 130 to the server terminal 110 is encrypted using commercially available encryption techniques to maintain data security and avoid potential third party access to such information. In such a case, the server terminal 110 may be configured to decrypt the encrypted information received from the user terminal 120 before performing further processings thereto.

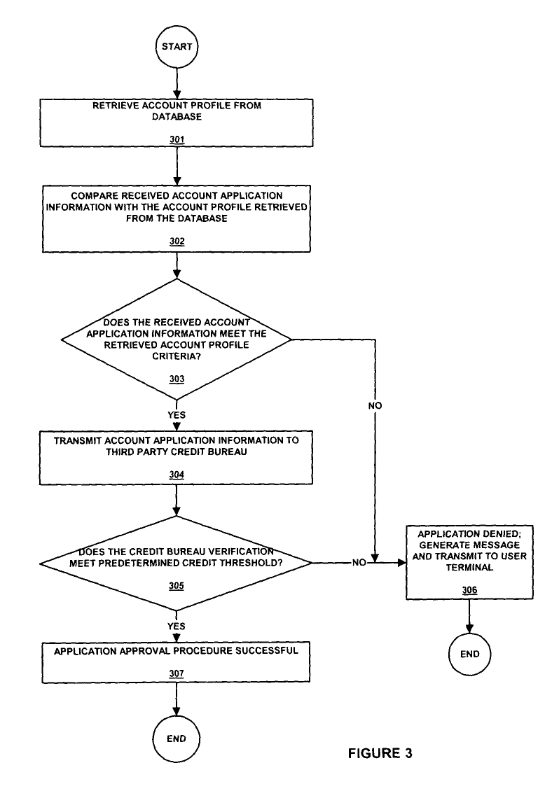

Referring back to FIG. 2, upon receiving the financial account application information including the applicant's bank account information at step 201, the server terminal 110 is configured to perform the initial approval procedure based on the received application information at step 202. As discussed in further detail in conjunction with FIG. 3, the initial approval procedure performed at step 202 may include verification of the applicant's contact information for accuracy, retrieving an account profile (for example, from one of the databases of the storage unit 150) suitable for the applicant based on the received application information such as annual income information and employment history to verify that the applicant's financial profile at least meets a predetermined risk tolerance level for extending credit (and thus ultimately approving for a financial account such as a credit card account).

The server terminal 110 at step 202 may also be configured to perform a credit check on the applicant using third party credit bureau based on the account application information received at step 201. In this manner, using the account application information received from the applicant at step 201, the server terminal 110 can determine whether the applicant's financial history has indication of adverse events such as bankruptcy, delinquent accounts, and the like which may affect the approval criteria for the financial account.

As can be seen from FIG. 2, at step 203, the server terminal 110 determines whether the initial approval procedure at performed at step 202 is successful. If not, at step 204, the server terminal 110 may be configured to transmit a request for additional or corrected account application information to the user terminal 120, and the initial approval procedure is performed again at step 202. On the other hand, if at step 203 the server terminal 110 determines that the initial account application approval procedure is successful, then at step 205 the server terminal 110 is configured to generate a credit card account corresponding to the applicant that transmitted the account application information. More specifically, at step 205, the server terminal may be configured to generate a unique user name and password assigned to the generated credit card account as well as a unique credit card account number. This information is then stored in the respective databases in the storage unit 150 of the server terminal 110. It should be further noted that when the server terminal 110 receives the account application information from the user terminal 120, in one embodiment, the server terminal 110 is configured to store the received application information in the storage unit 150 so that the information may be updated and/or retrieved for additional processing.

Referring again to FIG. 2, after generating the credit card account corresponding to the received account application information at step 205, the server terminal 110 at step 206 may be configured to perform account link verification procedure with the bank account information received with the account application information a step 201. More specifically, in one embodiment, the server terminal 110 may be configured to randomly generate a predetermined number of nominal deposit amounts, and deposit those generated amounts into the bank account corresponding to the bank account information received at step 201. The applicant is then notified that such predetermined number of nominal deposits have been made to his account, and that to complete the credit card account application process, the applicant must retrieve the deposited amounts from his bank account independently and to transmit the deposited amounts to the server terminal 110.

In one embodiment, the server terminal 110 may be configured to randomly generate two or more deposit amounts under 50 cents and deposits those amounts to the applicant's bank account electronically. Thereafter, the server terminal 110 may be configured to transmit a message to the user terminal 120 notifying the applicant that such deposits have been made and that the applicant must retrieve those deposit amounts and transmit them back to the server terminal 110 within a predetermined time period such as within 48 hours of the notification to the applicant.

Thereafter at step 207, it is determined whether the account link verification procedure of step 206 is successful. In other words, the server terminal 110 determines whether the correct deposited amounts are received within the predetermined time period from the user terminal 120. If at step 207 it is determined the account link verification procedure is not successful, then at step 208, the server terminal 110 generates an account link verification failure notification and transmits the failure notification to the user terminal 120 along with a request to re-submit the predetermined deposited amounts. Alternatively, if the applicant transmits the correct deposit amounts to the server terminal 110, but the predetermined time period for transmitting the deposit amounts has lapsed, then in one embodiment, the application process terminates and the generated credit card account is provided with an account closed status. In this case, the server terminal 110 generates an application failure notification and transmits the notification to the user terminal 120. In an alternate embodiment, the server terminal 10 may also redirect the applicant to a new webpage to initiate a new account application procedure.

Referring yet again to FIG. 1, if the account link verification is determined to be successful at step 207, then at step 209, the server terminal 10 is configured to receive debit amount information from the user terminal 120 for establishing the periodic debit amount from the linked bank account to fulfill the payment obligations of the now approved and linked credit card account for the applicant. With the debit amount information that meets a predetermined threshold level, the server terminal 110 is configured to transmit the approved credit card account information such as the credit card number and the expiration date to the user terminal 120 with instructions for the applicant to activate the credit card. In one embodiment, as discussed in further detail below, the predetermined threshold level for the periodic debit amount from the linked bank account requested by the application may include one or a combination of the monthly minimum payment, a fixed monthly payment amount which exceeds the monthly minimum payment, or the full credit card balance amount at the end of each billing cycle.

In the manner described above, in accordance with one aspect of the present invention, financial accounts such as a credit card account may be generated and approved for consumers whereby the application process lowers the risk of potentially high risk credit card holders (e.g., sometimes referred to as “un-banked”, defined as a consumer who has no valid bank account), and further minimizing the delay or lapse in periodic payment of the recurring credit card balance by requiring a direct debit transaction from the credit card holder's bank account as a pre-requisite for the credit card account approval process as well as the on-going good standing of the credit card account. Accordingly, by effectively lowering potential default rates on the credit card accounts, and increasing the cash flow for payment transactions, lower interest rates and other benefits may be offered to the account applicants to benefit therefrom if they choose to not pay the entire outstanding balance at the end of each billing cycle. This on-going record of customer application, purchase and payment activity via the linked bank account on a regular and reoccurring basis, provides the financial institution a consistent process in which it may track and score the probability of the customer performing fraudulent activity or defaulting for the duration of the account. This ability materially increases the financial institutions ability to mitigate and prevent charge off.

FIG. 3 is a flowchart illustrating the account application approval procedure (credit verification) procedure of step 202 in FIG. 2 in accordance with one embodiment of the present invention. Referring to FIG. 3, at step 301, based on the account application information received from the applicant, the server terminal 110 may be configured to retrieve an account profile for example, a cash advance level and initial credit line level, from the database such as in the storage unit 150 that substantially corresponds to the applicant's annual income information and employment information. More specifically, at step 302, the server terminal 110 is configured to compare the received account application information with the retrieved account profile, and at step 303, it is determined whether the received account application information meet the retrieved account profile criteria such as annual income level, employment history criteria, and the like. In one embodiment, the retrieved account profile criteria may include in-house account approval conditions including, for example, applicant's financial profile based on the information received from the applicant.

Referring back to FIG. 3, if at step 303 it is determined that the received account application information does not satisfy the retrieved account profile criteria, then at step 306, it is determined that the account application is not suitable for a credit card account, and thus, the server terminal 110 is configured to generate a notification message denying the account application and transmits the notification message to the user terminal 120. On the other hand, it at step 303 it is determined that the received account application information meets the retrieved account profile criteria, then at step 305, the applicant's account application information (for example, applicant's name and social security number information) is transmitted to the third party credit bureau 160 (FIG. 1) via the data network 130 (FIG. 1) to perform a credit check on the applicant's financial profile. In response to the request for the credit check, the credit bureau 160 performs a credit verification based on the applicant information received from the server terminal 110 and transmits the resulting credit result to the server terminal 110.

Thereafter, at step 305 it is determined whether the credit result (credit bureau verification) received from the credit bureau 160 (FIG. 1) meets a predetermined credit threshold necessary for approval of the credit card application. It should be noted that the retrieved account profile discussed above may include the predetermined credit threshold level as well. For example, the predetermined credit threshold in one embodiment may include a substantially clean credit record (i.e., without bankruptcies or delinquent accounts over the past five years), and with a credit score rating above a given level.

If at step 305 it is determined that the credit result received from the credit bureau 160 does not meet the predetermined credit threshold based on the applicant's account application information, then at step 306, it is determined that the application for the credit card application is denied, and the server terminal 110 in configured to generate and transmit a notification of account denial to the user terminal 120. However, if at step 305 it is determined that the credit result received from the credit bureau 160 does satisfy the predetermined credit threshold, then at step 307 it is determined that the application approval procedure is successful, and the process returns to step 205 (FIG. 2) to generate the credit card account corresponding to the creditworthy applicant.

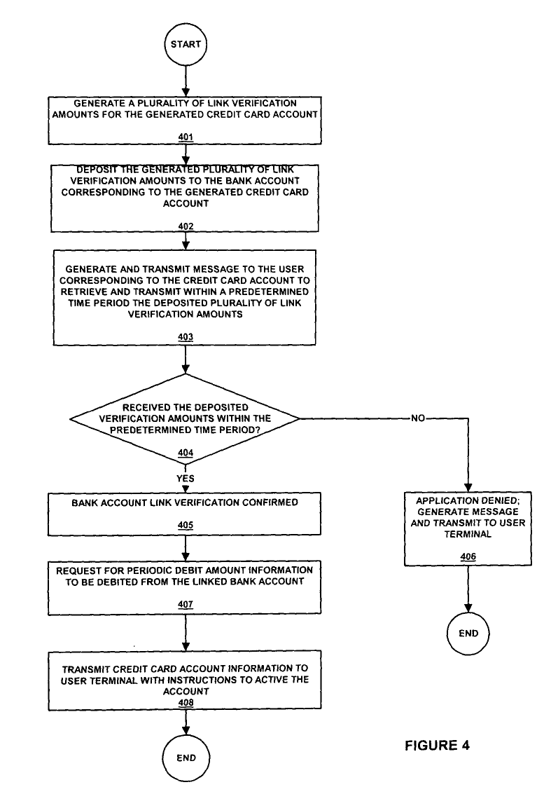

FIG. 4 is a flowchart illustrating the bank account link verification procedure discussed above in conjunction with step 206 (FIG. 2) in accordance with one embodiment of the present invention. More specifically, at step 401, the server terminal 110 is configured to randomly generate a plurality of nominal bank deposit amounts (account link verification amounts) for the generated credit card account. As discussed above, in one embodiment, the plurality of nominal bank deposit amounts randomly generated may include one or more deposit amounts not exceeding a predetermined level such as 50 cents.

Referring back to FIG. 4, thereafter at step 402, the server terminal 110 performs a deposit transaction into the bank account at the financial institution 140 (FIG. 1) of the applicant, and establishes a communication link between the generated credit card account and the applicant's bank account. After depositing the link verification amounts into the bank account, the server terminal 110 at step 403 is configured to generate a notification transmitted to the user terminal 120 to instruct the applicant to independently retrieve the deposit amounts from the applicant's bank account within a predetermined time period and to verify those deposit amounts by transmitting the amounts to the server terminal 110. As discussed above, the predetermined time period may be, for example, 48 hours (or any other suitable time period) from the time of notification of the application regarding the verification deposit transaction.

Thereafter at step 404, it is determined whether the server terminal 110 has received the deposited verification amounts within the predetermined time period from the user terminal 120. If it is determined that the server terminal 110 has not received either the correct deposited verification amount, or the correct verification amounts, but the predetermined time period has lapsed, or that inaccurate verification amounts are received after the predetermined time period has lapsed, then at step 406, it is determined that the application for the credit card account is denied, and the server terminal 110 is configured to generate an application denied notification message and to transmit the same to the user terminal 120. In an alternate embodiment, the applicant may be provided with a predetermined number of attempts to transmit the correct verification deposit amounts within the predetermined time period, and if the number of unsuccessful attempts have exceeded the permissible number of attempts, the applicant is notified that the application is denied.

Referring yet again to FIG. 4, if on the other hand it is determined at step 404 that the received deposited verification amounts received from the applicant within the predetermined time period is accurate (i.e., the amounts exactly match the amounts deposited into the applicant's bank account), then at step 405 it is determined that the bank account link verification is confirmed. In other words, the generated credit card account for the applicant is now linked to the applicant's bank account for purposes of debit transactions, account payments and on-going validation and the like as discussed in further detail below. After confirming applicant's bank account link verification, at step 407, the server terminal 110 transmits a notification to the user terminal 120 to provide a desired periodic debit amount information to be debited from the applicant's bank account to offset against the outstanding balance in the applicant's credit card account. In one embodiment, the user terminal 120 may be provided with a graphical representation of a plurality of debit amount selection options such as for the selection of full payment for each billing cycle, for minimum payment for each billing cycle, or for the minimum payment plus an additional amount for each billing cycle. Upon receiving the desired periodic debit amount information from the user terminal 120, at step 408, the server terminal 110 is configured to transmit the credit card account information to the applicant (i.e., to the user terminal 120) notifying that the applicant's credit card account has been approved.

In one embodiment, the notification of application approval including the credit card account number and related account information may be securely transmitted to the applicant's email account over the data network 130. The applicant may then activate the credit card (by, for example, calling from the applicant's home telephone the appropriate telephone number for account activation) for immediate use. Additionally, the corresponding physical credit card may be mailed separately to the applicant's address.

It should be noted that the various processes described above including the sets of instructions for operating in the software application execution environment at the controller 160 as discussed in conjunction with the Figures, may be embodied as computer programs developed using an object oriented language that allows the modeling of complex systems with modular objects to create abstractions that are representative of real world, physical objects and their interrelationships. The software required to carry out the inventive process, which may be stored in the server terminal 110, and more specifically, in the storage unit 150 of the server terminal 110, may be developed by a person of ordinary skill in the art and may include one or more computer program products.

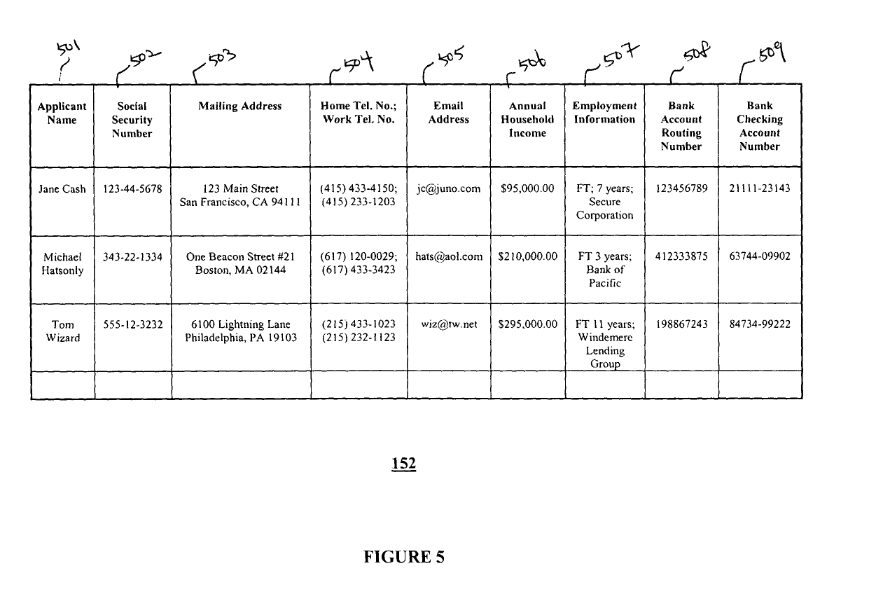

FIG. 5 is a tabular illustration of the account application information received by the server terminal and stored in the database at the server terminal in accordance with one embodiment of the present invention. Referring to the Figure, the account database 152 in one embodiment includes an applicant name field 501 for storing the respective applicant's name information received with the account application information from the user terminal 120. Also shown in FIG. 5 are a social security number field 502 for storing the respective applicant's social security number required to process the account application, a mailing address field 503 for storing the applicant's mailing address, a home and work telephone number field 504 for storing the applicant's home and work telephone numbers, an email address field 505 for storing the applicant's email address information, an annual household income field 506 for storing the applicant's annual household income information, an employment information field 507 for storing the applicant's employment information, a bank account routing number field 508 for storing the applicant's banking account routing number information, and a bank checking account number field 509 for storing the applicant's checking account number information.

It should be noted that within the scope of the present invention, other information may be requested from the applicant for the initial account application completion in addition to or in lieu of at least some of the information stored in the respective data fields in the account database 152. However, the applicant's bank account routing number information and the bank checking account number information, as well as the applicant's email address must be provided by the applicant in order to initiate the account application procedure.

By way of an example, the applicant may initiate the credit card account application process at the user terminal 120 (FIG. 1) by completing the appropriate fields on the user interface (such as a webpage) which prompt for personal as well as financial information of the applicant. More specifically, the account application webpage may include data fields to prompt the application to provide the applicant's name, social security number, mailing address, telephone numbers, email address, income and employment information, and the applicant's bank account information. By entering the appropriate data in each of the respective fields on the account application user interface and executing a transmit function to transmit the data to the server terminal 110 (FIG. 1), the applicant initiates the credit card application procedure. Upon receiving the application information from the user terminal 120 (FIG. 1), the server terminal 110 (FIG. 1) is configured to store the respective data in the appropriate fields in the account database 152 of the storage unit 150.

Referring back to FIG. 5, as can be seen, applicant named Jane Cash with social security number 123-44-5678 maintains a mailing address at 123 Main Street in San Francisco, Calif. 94111, whose home telephone number is (415) 433-4150, and work telephone number is (415) 233-1203. It can further seen from FIG. 5 that Jane Cash as an email address at jc@juno.com and her annual income is $95,000.00 at Secure Corporation where she has been working full time (FT) for the past seven years. Also shown in the account database 152 for Jane Cash is that her checking account number is 21111-23143 and her banking institution for the checking account has a routing number of 123456789. In this manner, with each received account application information, the server terminal 110 (FIG. 1) may be configured to perform data sort function under the control of the controller 160 to store the received information in the appropriate fields within the database, and also to retrieve and/or update the data as needed.

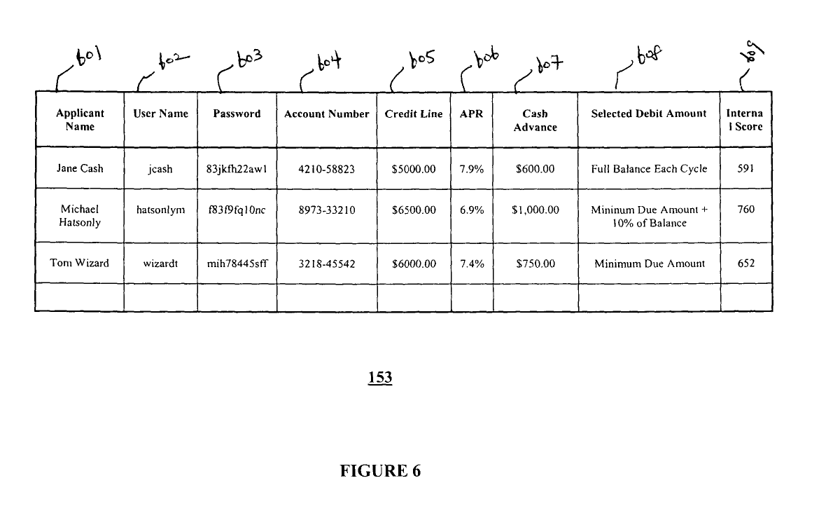

FIG. 6 is a tabular illustration of the credit card account information stored in the database at the server terminal in accordance with one embodiment of the present invention. Referring back to FIG. 2, at step 205, when the credit card account corresponding to the received account application information is generated, the user database 153 (FIG. 1) is accessed by the controller 160 of the server terminal 110. More specifically, a user name and password pair is generated by the controller and correlated with the respective applicant. Also, a credit card account number is assigned to the applicant, along with the approved credit line, cash advance limit, and the applicable APR percentage.

Referring to FIG. 6, it can be seen that the user database 153 includes an applicant name field 601, a user name field 602, a password field 603, an account number field 604, a credit line field 605, an APR field 606, a cash advance field 607, a selected debit amount field 608, and an internal score field 609. As discussed above, when the credit card account is generated after the initial credit approval procedure, the controller 160 assigns and stores the user name and password information for each credit account and respectively stores in the user name field 602 and the password field 603. Furthermore, the corresponding account number assigned by the controller 160 is similarly stored in the respective account number field 604. Additionally, the credit line and cash advance limit as well as the applicable APR percentage are respectively determined for each generated credit card account and stored in the credit line field 605, APR field 606 and the cash advance field 607, respectively.

By way of an example, as can be seen from FIG. 6, applicant named Michael Hatsonly is assigned a user name “hatsonlym” with password “f83f9fq10nc” for the credit card account having an account number of 8973-33210 with a credit line of $6,500.00 and a cash advance limit of $1,000, and an APR rate of 6.9%. In one embodiment, the determination of the suitable credit line, cash advance limit and the APR is based on user provided income and employment information as well as credit history verified through the credit bureau 160 (FIG. 1).

Also shown in FIG. 6 is the selected debit amount field 608 which is configured to store the user selected periodic debit amount to be debited from the user's linked bank account to apply to the credit card account balance at the end of each billing cycle. When the user (after successfully completing the bank account link verification procedure) selects the desired periodic debit amount to be taken out of the user's bank account periodically, that information is received by the server terminal 110 and stored in the respective selected debit amount field 608 of the user database 153 in the storage unit 150 and subsequently appended to the customers credit score and tracked as an on-going behavioral attribute, which ultimately, will be used as a predictor of customer behavior.

More specifically, referring yet again to FIG. 6, there is also provided the internal score field 609 in the user database 153 which is configured to store an internal credit score information for each applicant in the user database 153 of the storage unit 150 in the server terminal 110. In one embodiment, the internal credit score information is determined based on the account application information received from the user terminal 120 during the application process, and thereafter, dynamically modified based upon third party credit bureau verification information, as well as during the life cycle of the respective credit card accounts based on, among others, the account usage, account payment history, delinquency frequency and/or status, and the like. Additionally, in a further embodiment of the present invention, the credit line, the APR and the cash advance information stored in the credit line field 605, the APR field 606, and the cash advance field 607, respectively, in the credit card account information database 153 may be configured to be dynamically adjusted contemporaneously to the modifications to the internal score information stored in the respective internal score field 609 of the user database 153.

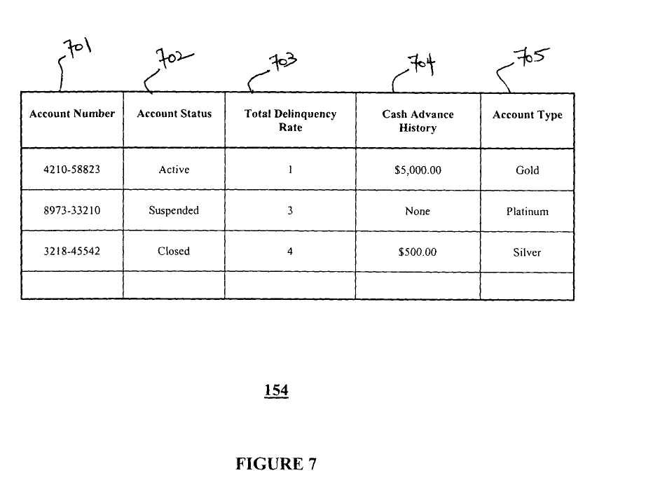

FIG. 7 is a tabular illustration of the default account information stored in the database at the server terminal in accordance with one embodiment of the present invention. Referring to the Figure, as can be seen, the default database 154 of the storage unit 150 in the server terminal 110 in one embodiment may include an account number field 701 for storing the credit card account number information, and an account status field 702 for storing the status of the account such as, for example, active status, suspended status (for example, for insufficient funds in the linked bank account to satisfy the selected periodic debit amount), or closed status for accounts that are closed. Also included in the default database 154 is a total delinquency rate field 703 which stores the number of occurrences for a delinquency in payment for the corresponding credit card account in cases of, for example, insufficient funds in the linked bank account discussed above.

The default database 154 may further be configured to include a cash advance history field 704 as well as account type field 705. In one embodiment, the cash advance history field 704 is configured to store the total amount of cash advance transactions executed for each account to monitor the rate of the account holder's activities.

Additionally, the account type such as Gold, Platinum or Silver types stored in the account type field may be generated and stored based on a predetermined credit card usage profile for each account. In one embodiment, the account type for each account may be configured to change based on the corresponding credit card usage, whereby for example, when the usage substantially conforms with low potential default risk profile, the account type may be upgraded from Gold type to Platinum type (e.g., higher credit line), and the corresponding benefits to the account holder would be offered such as lower APR rates, higher cash advance limit, and larger credit line, for example. Moreover, within the scope of the present invention, other data and information relevant to the overall functionality and servicing of the credit card accounts may be included in the default database 154 such that the database 154 may include additional data fields.

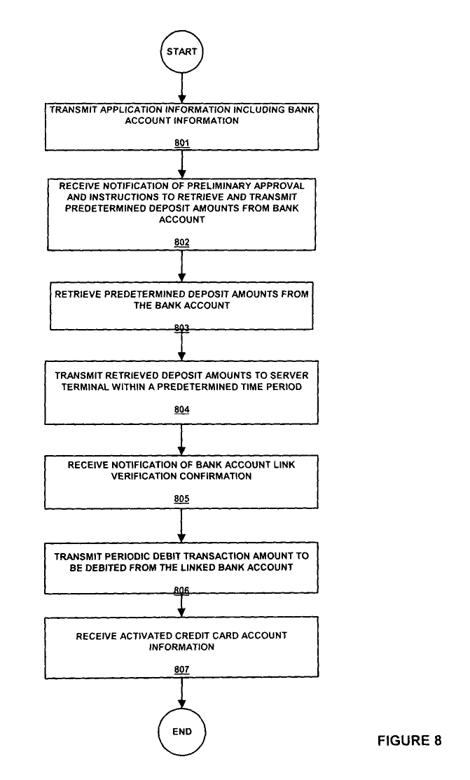

FIG. 8 is a flowchart illustrating the account application procedure at the user terminal in accordance with one embodiment of the present invention. Referring to the Figure, at step 801, a user who wishes to apply for a financial account such as a credit card account, at a user terminal 120 (FIG. 1), accesses the webpage which displays the application form to apply for the credit card account as well as information related to the terms and conditions of the credit card account. In one embodiment, the webpage on the user terminal 120 includes a pre-formatted user interface screen which prompts for specific information which is necessary to initiate the credit card account application process including the applicant's bank account information. Upon completing the entry of the various information prompted at the user terminal 120 (FIG. 1), the user executes a transmit or equivalent function to transmit the information inputted by the applicant at the user terminal 120 (FIG. 1) to the server terminal 110 (FIG. 1) via the data network 130 (FIG. 1).

In one embodiment, at the user terminal 120 (FIG. 1) the applicant is provided with a brief description, on the webpage in which the applicant is prompted to provide the information necessary to initiate the credit card application process, that the information that the applicant is providing will be securely transmitted over the data network 130 (FIG. 1). Alternatively, the indication that the information will be securely transmitted over the data network 130 may be displayed using a graphical representation at the user terminal 120 by using, for example, a suitable graphical icon.

Referring back to FIG. 8, after transmitting the account application information at step 801, the applicant step 802 receives a notification from the server terminal 110 (FIG. 1) of a preliminary account approval and a set of instructions requiring the applicant to retrieve and transmit one or more verification deposit amounts from the applicant's bank account which information applicant provided at step 801. In one embodiment, the set of instructions to retrieve and transmit the one or more verification deposit amounts include the time period within which the applicant must transmit the verification deposit amounts, a failure of which will result in account application denial. Thereafter at step 803, applicant accesses applicant's bank account either via online banking services over the internet (if available), or by telephone to the banking institution, to retrieve the one or more verification deposit amounts, and at step 804, the applicant transmits the retrieved verification deposit amounts to the server terminal 110 (FIG. 1).

When the one or more verification deposit amounts transmitted by the applicant to the server terminal 110 (FIG. 1) is confirmed, at step 805, the applicant receives a notification at the user terminal 120 (FIG. 1) that the account link procedure to link the applicant's bank account to the applicant's credit card account has been verified and confirmed. Thereafter, at step 806, the applicant selects and transmits to the server terminal 110 (FIG. 1) the desired periodic debit transaction amount to be debited from the applicant's linked bank account to apply to the balance of the applicant's credit card account.

Finally, referring yet again to FIG. 8, the applicant at step 807 is notified by the server terminal 110 (FIG. 1) that the applicant's credit card account is approved and also, receives instruction to activate the approved credit card account as well as information confirming applicant's selected periodic debit transaction amount to be withdrawn from the applicant's now linked bank account to apply to the outstanding balance of the credit card account. As discussed above, in one embodiment, the applicant may choose to pay off the entire outstanding balance of the credit card account at the end of each billing cycle from the applicant's bank account.

Alternatively, the applicant may select to pay the minimum amount due at the end of each billing cycle, thus maintaining an outstanding balance carried over into the next billing cycle. As a further option, the applicant may select to make the minimum amount due plus an additional predetermined amount to be applied to the outstanding balance on the credit card account paid from the funds in the applicant's linked bank account. For each of these options, the applicant is notified of the necessity to maintain a minimum balance amount in the linked account at all times, and further, of the penalty provisions which may apply (including penalty repricing, suspension or revocation of the credit card account) in the event that the linked bank account balance does not meet the minimum balance requirement.

As will be discussed in further detail below, in one embodiment, the linked bank account which maintains a predetermined balance level at all times may be provided with a preferential status for the corresponding linked credit card account such as with one or more of a corresponding lower APR, higher cash advance level, and a larger credit line level. In one embodiment, the predetermined balance level may include one of a minimum balance due, an average of the immediately preceding three billing cycle total account balances, and the credit card account balance at the time linked bank account is queried for balance information. Indeed, in one embodiment, the server terminal 110 may be configured to periodically and/or randomly transmit request for balance information to the linked bank account for the corresponding credit card account, and based on the received linked bank account balance information, the server terminal 110 may be configured to modify one or more of the APR information, the cash advance information, and the credit line information stored in the APR field 606, the cash advance field 607, and the credit line field 605, respectively, of the corresponding credit card account.

Alternatively, the server terminal 110 may be configured to verify the linked bank account balance information at a predetermined periodic interval such as at the time the account balance becomes due for a given billing cycle, and as long as the linked bank account maintains sufficient funds to payoff the user specified periodic debit transaction amount, the corresponding credit card account is maintained in good standing, and not entering the account default status.

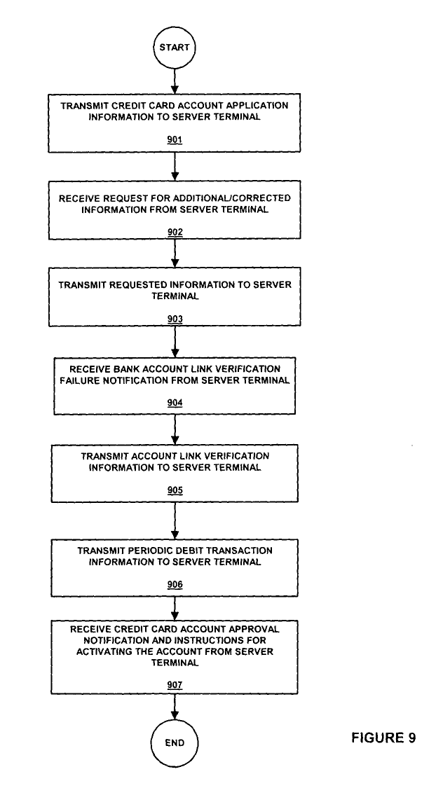

FIG. 9 is a flowchart illustrating the account application procedure at the user terminal in accordance with another embodiment of the present invention. Referring to the Figure, at step 901, the user at the user terminal 120 transmits the credit card account application information to the server terminal 110. Thereafter, at step 902, the user terminal 120 receives from the server terminal 110 a request for additional and/or corrected information based supplementing and/or correcting previously transmitted credit card account application information. In response thereto, the user/applicant at the user terminal 120 transmits the requested additional and/or corrected information to the server terminal 110 at step 903. In this manner, the user who is applying to open a credit card account is provided with opportunities to modify or otherwise correct information transmitted to the server terminal 120 for the credit card account application.

Referring to FIG. 9, at step 904, the applicant receives at the user terminal 120 a bank account link verification failure notification from the server terminal 110. It should be noted that in one embodiment, the credit card account application information transmitted to the server terminal at step 901 includes the user's bank account from which, the user desires to debit the periodic payment of the outstanding balance of the credit card account. Referring back to FIG. 9, the applicant at step 905 retransmits the linked bank account verification information including those which are requested by the server terminal 120 such as the bank routing number information, the bank account number information, and the bank contact information. Thereafter, the applicant transmits the desired periodic debit transaction amount information to the server terminal 120 specifying the amount that the applicant wishes to pay off of the outstanding balance which will be due on the credit card account at the termination of each billing cycle.

After transmitting the desired periodic debit transaction amount information to the server terminal 120, the applicant at the user terminal 120 receives from the server terminal 110 with a credit card account approval notification as well as instructions for activating the account. In one embodiment, the account approval notification information may include, among others, the credit card account number information, the credit card account validity date information, the credit card account credit line information, the credit card account cash advance information, the credit card account APR information, as well as other necessary disclosure information as required by the governing laws. Furthermore, with the received instructions for the activation of the credit card account, the applicant may immediately perform the necessary steps (for example, such as by calling a specified telephone number for account activation, or alternatively, securely logging onto the server terminal 120 website configured for account activation procedures) and is able to use the credit card before the physical card is received by the applicant.

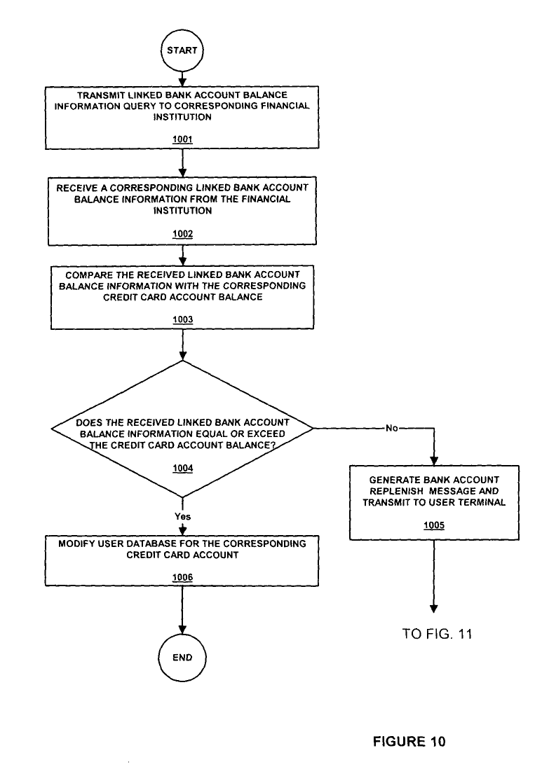

FIG. 10 is a flowchart illustrating the linked bank account balance information verification procedure for the corresponding credit card account in accordance with one embodiment of the present invention. Referring to FIG. 10, at step 1001, the server terminal 120 is configured to transmit a linked bank account balance information query to the corresponding financial institution to request the linked bank account balance information for a credit card account which has been approved and in use. In response thereto, at step 1002, a linked bank account balance information is received from the financial institution. The server terminal 120 is then configured in one embodiment to compare the received linked bank account balance information with the corresponding credit card outstanding account balance amount.

Referring back to FIG. 10, at step 1004, the server terminal 110 determines whether the received linked bank account balance amount equals or exceeds the credit card outstanding account balance amount. If at step 1004 it is determined that the received linked bank account balance amount equals or exceeds the credit card account outstanding balance, then at step 1006, that information is stored in the user database 153 (FIG. 6) to reflect the result of the comparison performed at step 1004. In one aspect of the present invention, the user database 153 may be updated in a manner consistent with the results of the procedure outlined in steps 1001 to 1006, such that, when it is determined that the linked bank account indeed has maintained a sufficient level of funds to pay off the entire credit card account balance (or a fraction thereof, including the minimum balance amount due, for example, as discussed in further detail below), the server terminal 110 may be configured to appropriately modify the corresponding values in the credit line field 605 (FIG. 6), the APR field 606, the cash advance field 607, and the internal score field 609 for that user.

For example, given a linked bank account of a credit card account which consistently maintains a balance exceeding the outstanding balance of the credit card account at the time of the linked account balance information query (step 1001), the server terminal may be configured to lower the corresponding value in the APR field 606 of the user database 153, increase the credit line so as to raise the value stored in the credit line field 605 of the user database 153, and/or increase the cash advance amount as reflected and stored in the corresponding cash advance field 607 of the user database 153. Conversely, for each occurrence of the linked bank account balance information query as shown in step 1001 of FIG. 10 which results at step 1004 in a determination that the balance information is less than the compared credit card account balance (or a minimum level as established the server terminal 11), then, the respective values of the APR information, cash advance level, and the credit line amount (as well as the internal score) for the user's credit card account may be adversely impacted. In other words, in this case, the APR value stored in the APR field 606 corresponding to the user's credit card account may be raised to a higher percentage, the credit line amount stored in the credit line field 605 may be lowered, and the cash advance level stored in the cash advance field 607 may be reduced (even to zero, as needed).

Additionally, it should also be noted that Within the scope of the present invention, with each occurrence of a modification to a credit card account such as, for example, a change to the credit line amount, a change to the corresponding APR, and/or a reduction or increase in the cash advance level, the credit card account holder is substantially contemporaneously notified of such modification to her account via an electronic notification procedure including, for example, an electronic mail (email) transmitted to the account holder's email account which is stored in the email address field 505 (FIG. 5) of the account database 152 for the corresponding credit card account holder.

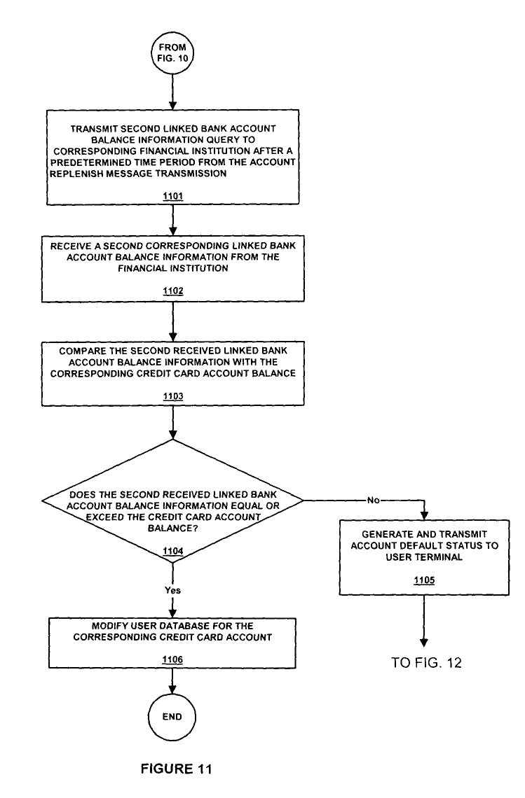

Referring back to FIG. 10, on the other hand, if at step 1004 it is determined that the received linked bank account balance information is less than the outstanding balance of the corresponding credit card account, then at step 1005, the server terminal is configured to generate a linked bank account replenish message and transmitted to the corresponding user terminal 120 of the credit card account holder. Thereafter, the process continues as illustrated in FIG. 11.

It should be noted that, within the scope of the present invention, the credit card account balance amount to which the received linked bank account balance information is compared may include an amount less than the entire outstanding credit card account balance amount, such as a minimum credit card account balance amount of each billing cycle. In such a case, the determination at step 1004 includes comparing the linked bank account balance information with the corresponding credit card account minimum payment amount for the respective billing cycle to ensure that the linked bank account has sufficient funds to pay at least the minimum balance due on the corresponding credit card account. In a further embodiment of the present invention, the credit card account balance amount to which the received linked bank account balance information is compared may include a value or sum ranging between the minimum amount due and the full outstanding balance.

FIG. 11 is a flowchart illustrating the linked bank account balance insufficient level processing procedure for the corresponding credit card account in accordance with one embodiment of the present invention. Referring to FIGS. 10-11, after transmitting the bank account replenish message to the user terminal at step 1005 (FIG. 5), the server terminal 110 is configured, at step 1101 (FIG. 11) to transmit a second linked bank account balance information query to the corresponding financial institution of the credit card account after a predetermined time period from the account replenish message transmission to the user terminal 120 at step 1005 (FIG. 10). In one embodiment, the predetermined time period for transmitting the second linked bank account balance information query may be 24 hours, 48 hours, 72 hours, or any other suitable time period during which the credit card account holder is provided with an opportunity to deposit additional funds in the linked bank account.

Referring back to FIG. 11, after transmitting the second linked bank account balance information at step 1101, the server terminal 110 receives a second corresponding linked bank account balance information from the financial institution at step 1102. Thereafter at step 1103, the server terminal 110 is configured to compare the second received linked bank account balance information with the corresponding credit card account balance. If it is determined at step 1104 that the second received linked bank account balance information equals or exceeds the credit card account balance, then at step 1106, the user database 153 of the server terminal 110 corresponding to the credit card account is accordingly modified to reflect as such.

It should be noted here that the discussion above in conjunction with the procedure performed at step 1006 (FIG. 10) is substantially equally applicable to the procedure performed at step 1106 of FIG. 11. However, in the case of the server terminal 110 transmitting a second linked bank account balance information query, the information stored in the user database 153 corresponding to the credit card account is modified to reflect such occurrence by, for example, a lowering of the internal score stored in the internal score field 609 (FIG. 6) of the user database 153.

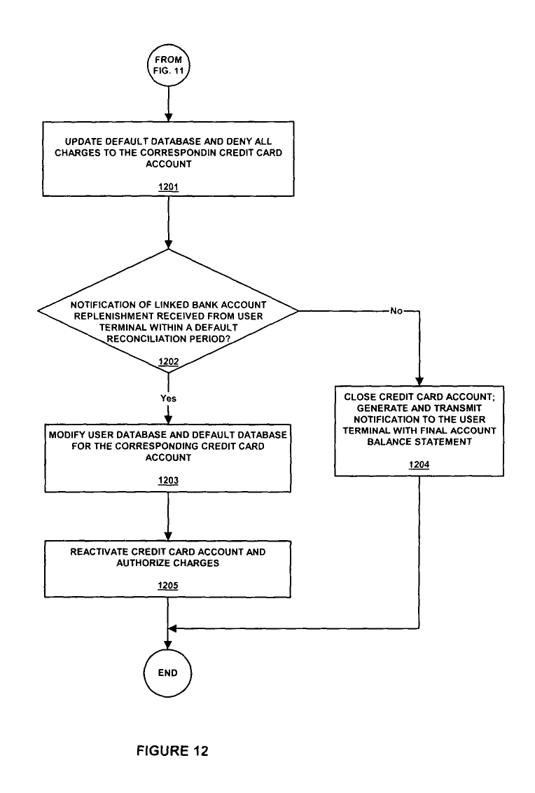

Referring again to FIG. 11, if at step 1104 it is determined that the second received linked bank account balance amount is insufficient to meet the credit card account balance (or a predetermined portion thereof, such as the minimum balance amount for the account discussed above), then at step 1105, the server terminal 110 is configured to generate and transmit an account default status to the corresponding user terminal 120. Thereafter, the processing continues as shown in FIG. 12 discussed in further detail below.

FIG. 12 is a flowchart illustrating the default credit card account processing procedure in accordance with one embodiment of the present invention. Referring to FIG. 12, after generating and transmitting the account default status to the user terminal 120 at step 1105 (FIG. 11), the procedure continues at step 1201 of FIG. 1 wherein the default database 154 for the corresponding credit card account is updated and all subsequent charges made to the credit card account are denied substantially immediately as of the account default status notification transmission. As such, transactions or attempted transactions to the credit card account are denied, and the information stored in the total delinquency rate field 703 is updated to reflect the account default status. Moreover, the account status field 702 of the default database 154 is similarly updated to modify the corresponding credit card account status from active, for example, to a suspended status (FIG. 7).

Referring back to FIG. 12, at step 1202, it is determined whether a notification of linked bank account replenishment is received from the user terminal within a predetermined default reconciliation period. For example, the credit card account holder may transmit an electronic mail notification to the server terminal 110 informing that the linked bank account has been replenished with additional funds to meet the minimum balance requirement as established for the credit card account. Alternatively, the financial institution for the linked bank account of the corresponding credit card account may be configured to transmit a notification to the server terminal 110 in the event that the financial institution receives one or more deposit transactions into the linked bank account such that the balance amount of the linked bank account meets or exceeds the minimum balance requirement (for example, the minimum monthly amount due, or the full outstanding balance of the credit card account, or any other level thereinbetween as determined by the server terminal 110 and/or agreed upon by the credit card account holder during the application process discussed above).

Referring yet again to FIG. 12, it at step 1202 it is determined that no notification of linked bank account replenishment is received with the reconciliation period, then at step 1204, the credit card account is closed, and likewise, modification to the default database 154 made, for example, to the account status field 702 (FIG. 7), and also, an account closure notification message notifying the credit card account holder that the account is closed is generated and transmitted to the account holder with a final account balance statement.

On the other hand, if at step 1202 it is determined that the server terminal 110 receives a notification of linked bank account replenishment within the reconciliation period, then at step 1203, the user database 153 and the default database 154 are updated to reflect, for example, the account status information in the account status field 702 of the default database 154 from a suspended status to an active status. Moreover, the user database 153 is updated, for example, to modify the internal score corresponding to the credit card account, as well as to lower the credit line, the raise APR and/or the lower the cash advance limit. Thereafter, at step 1205, the account is reactivated and the charge privilege to the credit card account is restored so that the account holder may successfully complete transactions on the credit card account.

In the manner described above, in accordance with the various embodiments of the present invention, there is provided a method and system for underwriting and servicing financial accounts such as credit card accounts which substantially lowers default risk due to nonpayment. More specifically, by requiring the account holders and applicants to maintain a minimum balance in the linked bank account to fund the credit card account balance at the end of each billing cycle, the significant risk related to delayed collection, and non-payment of outstanding balances are substantially reduced. Alternatively, in a further embodiment, preferential account servicing and status is provided to credit card accounts whose corresponding linked bank account that continuously maintains a balance level which is at least the user specified periodic debit transaction amount. Some examples of preferential account servicing and status may include, for example, one or more of a preferred rate for the APR, a higher cash advance level, and a higher credit line. In this manner, the credit card account holders may be offered lower interest rates on their outstanding balances and avoid late fees.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

1. A method of providing underwriting and/or servicing of an financial account, comprising the steps of:
receiving account application information including a bank account information;
depositing at least one deposit amount to the bank account corresponding to the received bank account information;
receiving a deposit verification amount;
comparing the received deposit verification amount with the deposited at least one deposit amount; and
generating a financial account corresponding to the received account application information, where the financial account is electronically linked to the bank account.

2. The method of claim 1 further including the step of receiving a periodic debit transaction amount.

3. The method of claim 2 wherein the periodic debit transaction amount is configured to be periodically debited from the bank account electronically to the financial account.

4. The method of claim 3 wherein the periodic debit transaction is performed at 30 day interval.

5. The method of claim 2 wherein the periodic debit transaction amount includes one of a full balance of the financial account, a minimum payment amount of the financial account, and a minimum payment amount of the financial account plus a predetermined payment amount.

6. The method of claim 1 further including the step of performing credit verification based on the received account application information.

7. The method of claim 6 wherein the step of performing credit verification includes the steps of:
transmitting the account application information to a credit bureau; and
receiving a credit history information corresponding to said transmitted account application information.

8. The method of claim 7 wherein the credit history information includes a numeric representation of the account application information.

9. The method of claim 1 wherein the financial account is a credit card account.

10. The method of claim 1 further including the step of generating an financial account default notification when the balance amount of the linked bank account falls below a predetermined minimum level.

11. The method of claim 10 further including the step of transmitting said financial account default notification.

12. A system for providing underwriting and/or servicing of an financial account, comprising:
a data network;
a user terminal operatively coupled to said data network configured to transmit and receive data therefrom;
a server terminal operatively coupled to said data network, said server terminal further configured to:
receive account application information including a bank account information from said user terminal;
deposit at least one deposit amount to the bank account corresponding to the received bank account information;
receive receiving a deposit verification amount from said user terminal;
compare the received deposit verification amount with the deposited at least one deposit amount; and
generate a financial account corresponding to the received account application information, where the financial account is electronically linked to the bank account.

13. The system of claim 12 wherein the server terminal is further configured to receive a periodic debit transaction amount from the user terminal.

14. The system of claim 13 wherein the server terminal is configured to periodically debited said periodic debit transaction amount from the linked bank account electronically to the financial account.

15. The method of claim 14 wherein the periodic debit transaction is performed at 30 day interval.

16. The system of claim 13 wherein the periodic debit transaction amount includes one of a full balance of the financial account, a minimum payment amount of the financial account, and a minimum payment amount of the financial account plus a predetermined payment amount.

17. The system of claim 12 wherein the server terminal is further configured to:
transmit the account application information to a credit bureau; and
receive a credit history information corresponding to said transmitted account application information.

18. The system of claim 12 wherein the financial account is a credit card account.

19. The system of claim 12 wherein the server terminal is configured to:
generate a financial account default notification when the balance amount of the linked bank account falls below a predetermined minimum level; and
transmit said account default notification to the user terminal.

20. A program storage device readable by a machine, tangibly embodying a program of instructions executable by the machine to perform a method of providing underwriting and/or servicing of an financial account, comprising the steps of:
receiving account application information including a bank account information;
depositing at least one deposit amount to the bank account corresponding to the received bank account information;
receiving a deposit verification amount;
comparing the received deposit verification amount with the deposited at least one deposit amount; and
generating a financial account corresponding to the received account application information, where the financial account is electronically linked to the bank account.
